(19) United States
(12) Patent Application Publication
(10) Pub. No.: US 2023/0274589 A1
(43) Pub. Date: Aug. 31, 2023

(54) Method and Device for Monitoring a Pressure Container System

(71) Applicant: Bayerische Motoren Werke Aktiengesellschaft, Muenchen (DE)

(72) Inventor: Christopher DETMAR, Muenchen (DE)

(21) Appl. No.: 18/009,070

(22) PCT Filed: May 20, 2021
(86) PCT No.: PCT/EP2021/063432

§ 371 Date: Dec. 8, 2022

(30) Foreign Application Priority Data
Jun. 9, 2020 (DE) 10 2020 115 313.9

(51) Int. Cl. G07C 5/08; G07C 5/00; G07C 5/02

(52) U.S. Cl. CPC G07C 5/0808; G07C 5/006; G07C 5/02; G07C 5/008

(57) ABSTRACT

A device for monitoring the use of a pressure container system of a piece of equipment, such as a motor vehicle, is designed to ascertain equipment-side usage data relating to previous use of the pressure container system. The device is additionally designed to compare the equipment-side usage data with equipment-external usage data relating to the previous use of the pressure container system and to initiate one or more measures relating to further use of the pressure container system on the basis of the comparison.

### BACKGROUND AND SUMMARY

The technology disclosed here concerns a pressure container system with one or more pressure containers, in particular for a motor vehicle. Furthermore, the technology disclosed here concerns a method and a corresponding device for monitoring a pressure container system.

A road motor vehicle may have a fuel cell stack, which generates electrical energy from a fuel such as hydrogen for the operation, in particular for the propulsion, of the vehicle. The fuel can be stored in one or more pressure containers of a pressure container system of the vehicle and can be fed to the fuel cell stack via lines when necessary.

The pressure container system of a vehicle is typically designed for a specific nominal use, for example, in relation to the number of refueling cycles, in relation to the service life, in relation to a maximum permissible pressure and/or in relation to a maximum permissible operating temperature. The use of the pressure container system beyond the nominal use can lead to an increased probability of failure of the pressure container system and the vehicle.

DE 10 2018 201064 A1, US 2013/226366 A1 and US 2008/189006 A1 describe systems for monitoring an odometer of a vehicle. U.S. Pat. No. 7,868,775 B2 describes a method for monitoring the number of filling cycles of a pressure container.

It is a preferred object of the technology disclosed here to reduce or remedy at least one disadvantage of a previously known solution or to propose an alternative solution. It is a preferred object of the technology disclosed here to enable reliable and safe monitoring of the use of a pressure container system, in particular to enable reliable operation of the pressure container system.

The object(s) may be achieved by the subject matter of the independent claims. The dependent claims represent preferred embodiments.

According to one aspect, a device for monitoring the use of a pressure container system of an equipment is described. The device may be, for example, part of the equipment or part of an external unit (outside the equipment). The pressure container system may comprise one or more pressure containers for storing a fuel (in particular hydrogen, or H₂). Furthermore, the equipment may include an energy converter which is set up to generate electrical energy for the operation of the equipment from fuel from the pressure container system. In a preferred example, the equipment is a motor vehicle (such as a passenger car, a truck, a motorcycle, a bus, etc.).

The pressure container system can be used in particular for the storage of gaseous fuel under ambient conditions. The pressure container system can be used, for example, in a motor vehicle that is operated with compressed natural gas (or CNG) or liquid natural gas (or LNG) or with hydrogen (especially H₂) as fuel. The pressure container system is typically fluidically connected to at least one energy converter that is designed to convert chemical energy of the fuel into one or more other forms of energy. The energy converter may include a fuel cell or a fuel cell stack.

The pressure container system typically comprises at least one pressure container, in particular a composite overwrapped pressure container. The pressure container may be, for example, a cryogenic pressure container or a high-pressure gas container.

High-pressure gas containers are designed to store fuel permanently at ambient temperatures at a nominal operating pressure (also called a nominal working pressure or NWP) of at least 350 bar overpressure (=overpressure compared to atmospheric pressure) or at least 700 bar overpressure. A cryogenic pressure container is suitable for storing the fuel at the aforementioned operating pressures even at temperatures that are significantly (for example more than 50 Kelvin or more than 100 Kelvin) below the operating temperature of the motor vehicle.

The pressure container system, in particular the one or more pressure containers of the pressure container system, may be designed for a nominal use. It may be necessary that the pressure container system is maintained or, if necessary, replaced after reaching the nominal use in order to continue to ensure reliable operation of the equipment.

The nominal use may include, for example, a nominal number of usage cycles (in particular cycles with one refueling phase and one extraction phase each) of the pressure container system. Alternatively or in addition, the nominal use may include a nominal service life of the pressure container system. Alternatively or in addition, the nominal use may include a nominal pressure (in particular a maximum permissible pressure) and/or a nominal pressure gradient (in particular a maximum permissible pressure gradient) of the fuel when using the pressure container system. Alternatively or in addition, the nominal use may include a nominal temperature (in particular a maximum permissible temperature) of the fuel when using the pressure container system.

The device may be configured or set up to determine equipment-side usage data in relation to the previous use of the pressure container system. The usage data can indicate the previous use of the pressure container system (since commissioning) in a cumulative manner. In particular, the equipment-side usage data can indicate: the total number of utilization cycles of the pressure container system to date; the previous service life of the pressure container system; the maximum pressure, minimum pressure and/or maximum pressure gradient caused by the previous use of the pressure container system; and/or the maximum and/or minimum temperature that occurred during the previous use of the pressure container system.

The device may be set up to obtain the equipment-side usage data from a local memory unit of the equipment and/or to store it on a local memory unit of the equipment. In other words, the equipment-side usage data can be determined and/or stored locally on the equipment. In this way, independent monitoring of the use of the pressure container system can be made possible.

The device may be set up to determine current data in relation to the current use of the pressure container system based on sensor data from one or more sensors of the pressure container system. The sensor data can, for example, indicate the pressure and/or the temperature in the pressure container system, in particular in a pressure container of the pressure container system. The equipment-side usage data can then be repeatedly updated based on the current data to determine the cumulative use of the pressure container system and to store it as usage data.

Due to the local determination and/or storage of the equipment-side usage data, there is a risk that the equipment-side usage data will be changed and/or manipulated by a user of the equipment (for example to simulate a reduced use of the pressure container system). This can lead to reduced reliability of the operation of the pressure container system and/or equipment.

The device may be set up to compare the equipment-side usage data with equipment-external usage data in relation to the previous use of the pressure container system. In principle, the external usage data can indicate the same information as the equipment-side usage data. In particular, the equipment-external usage data can indicate: the total number of usage cycles of the pressure container system achieved to date; the previous service life of the pressure container system; the maximum pressure and/or maximum pressure gradient caused by the previous use of the pressure container system; and/or the maximum and/or minimum temperatures that occurred during the previous use of the pressure container system.

The device may be set up to obtain the equipment-external usage data from an external unit arranged outside the equipment (in particular from a database) and/or to store it on an external unit arranged outside the equipment. Alternatively or in addition, the equipment-external usage data may be protected against manipulation and/or modification by one or more security methods, in particular by using a blockchain.

As explained above, the device may be set up to determine current data regarding the current use of the pressure container system based on sensor data from one or more sensors of the pressure container system. Furthermore, the device may be set up to send the current data to the external unit outside the equipment to allow the external unit to update the equipment-external usage data. The equipment-external usage data can thus be repeatedly updated on the basis of the current data in order to determine (outside the equipment) the cumulative use of the pressure container system and to store it as usage data.

Thus, equipment-external usage data can thus be used as a reference for the (non-manipulated) usage of the pressure container system and compared with the equipment-side usage data. On the basis of the comparison of the equipment-side usage data with the equipment-external usage data, it can then be checked in a reliable manner whether the equipment-side usage data has been changed and/or manipulated.

Furthermore, the device may be set up, depending on the comparison, to initiate one or more measures in relation to the further use of the pressure container system. The one or more measures in relation to the further use of the pressure container system can be initiated in particular if it is determined that the equipment-side usage data have been changed and/or manipulated. Alternatively or in addition, the one or more measures may be initiated in relation to the further use of the pressure container system if the comparison shows that the previous use of the pressure container system indicated by the equipment-side usage data deviates from the previous use of the pressure container system indicated by the equipment-external usage data (and thus there may be manipulation of the equipment-side usage data).

By comparing equipment-side usage data with equipment-external usage data, particularly reliable monitoring of the use of a pressure container system and, as a result, particularly reliable operation of the pressure container system or the equipment, can be made possible.

The one or more measures in relation to the further use of the pressure container system may include:
blocking and/or preventing further use of the pressure container system;
issuing a notice to a maintenance service and/or to an official body (for example to the road traffic office or to the police) and/or to the user of the equipment to the effect that a review of the previous use of the pressure container system and/or maintenance of the pressure container system is required before further use of the pressure container system; and/or
locating the pressure container system in order to enable a review of the previous use of the pressure container system and/or maintenance of the pressure container system.

Such measures can enable particularly reliable operation of the pressure container system and/or the equipment.

The device may be set up to check, on the basis of the equipment-side usage data and/or on the basis of the equipment-external usage data, whether the nominal use of the pressure container system has been reached or exceeded by the previous use of the pressure container system. Furthermore, the device may be set up to initiate the one or more measures in relation to the further use of the pressure container system (if appropriate only) if it is determined that the previous use of the pressure container system has reached or exceeded the nominal use of the pressure container system. In this way, a reliable restriction of the pressure container system to the specified nominal use can be achieved, which enables reliable operation of the pressure container system and/or the equipment.

As already explained above, the pressure container system is typically designed to be used in the context of the operation of the equipment (for example to hold and/or provide fuel for the operation of the equipment). The device may be set up to determine operating data relating to the operation of the equipment. Exemplary operating data are the operating performance of the equipment (for example the distance travelled by a motor vehicle) and/or the operating time of the equipment.

Furthermore, the device may be set up to compare the equipment-side usage data and/or the equipment-external usage data with the operating data to check whether the equipment-side usage data and/or the equipment-external usage data have been manipulated and/or changed. In particular, as an alternative or in addition to the comparison with the equipment-external usage data, a comparison with operating data of the equipment can be carried out in order to check the plausibility of the equipment-side usage data. In this way, manipulation of the equipment-side usage data can be detected in a particularly reliable manner. Depending on the comparison of the equipment-side usage data with the operating data, one or more measures can then be initiated in relation to the further use of the pressure container system (especially in the case of a detected manipulation). In this way, particularly reliable operation of the pressure container system and/or the equipment can be made possible.

According to another aspect, a pressure container system is described, especially for a motor vehicle. The pressure container system includes the device described in this document.

According to another aspect, a (road) motor vehicle (in particular a passenger car, a truck, a bus, or a motorcycle) is described, which includes the pressure container system described in this document and/or the device described in this document.

According to a further aspect, a method for monitoring the use of a pressure container system of an equipment (in particular a motor vehicle) is described. The method includes the determination of equipment-side usage data in relation to the previous use of the pressure container system. Furthermore, the method includes the comparison of the equipment-side usage data with equipment-external usage data in relation to the previous use of the pressure container system. In addition, the method includes effecting or initiating one or more measures in relation to the continued use of the pressure container system depending on the comparison.

According to another aspect, a software (SW) program is described. The SW program can be set up to run on a processor (for example on a vehicle control unit) and thereby to perform the method described in this document.

According to another aspect, a memory medium is described. The memory medium may include a SW program that is set up to run on a processor and thereby to perform the method described in this document.

It should be noted that the methods, devices and systems described in this document can be used both alone and in combination with other methods, devices and systems described in this document. Furthermore, any aspect of the methods, devices and systems described in this document can be combined in a variety of ways. In particular, the features of the claims can be combined in a variety of ways.

### BRIEF DESCRIPTION OF THE DRAWINGS

The invention is described in more detail below on the basis of exemplary embodiments. In the figures

FIG. 1 shows an exemplary pressure container system;

FIG. 2 shows an exemplary system for monitoring a pressure container system of a vehicle; and

FIG. 3 shows a flowchart of an exemplary method for monitoring a pressure container system.

### DETAILED DESCRIPTION OF THE DRAWINGS

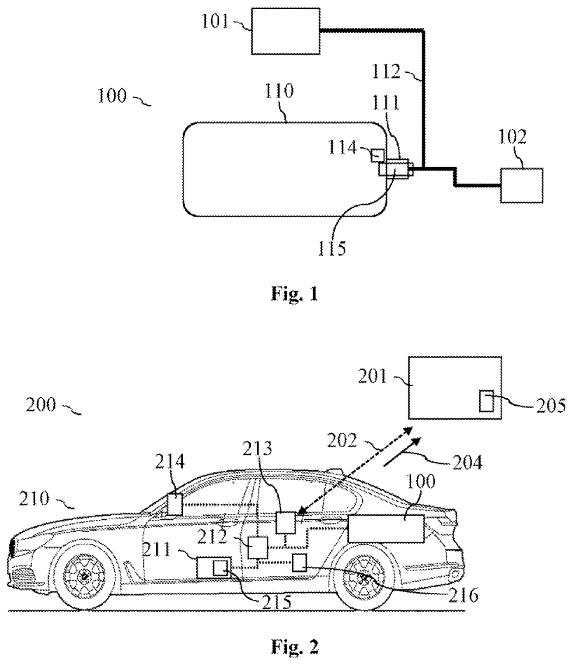

As explained at the beginning, this document deals with the reliable and safe monitoring of the use of a pressure container system. In this context, FIG. 1 shows an exemplary pressure container system 100 with a pressure container 110, which can be used to produce fuel (in particular hydrogen, or H₂) for an energy converter (for example for a fuel cell or for a fuel cell stack) 101. The pressure container 110 is connected to the energy converter 101 via a line 112. The pressure container 110 may have an opening at an end piece 111 through which the fuel from the pressure container 110 can be passed (for example via a valve 115 to the line 112). The pressure container 110 can be refueled with fuel via a refueling access 102.

The pressure container system 100 is typically designed for a specific nominal usage. The nominal usage can be defined here:
a certain nominal number of cycles (i.e. cycles with one refueling phase and one fuel withdrawal phase each) of the pressure container 110 of the pressure container system 100;
a certain minimum or maximum nominal pressure of the fuel in the pressure container 110, which the pressure should not fall below or exceed;
a certain minimum or maximum nominal temperature of the fuel in the pressure container 110, which the temperature should not fall below or exceed; and/or
a certain nominal service life of one or more components, in particular the pressure container 110, the pressure container system 100, which should not be exceeded.

FIG. 2 shows an exemplary system 200, which has at least one vehicle 210 with a pressure container system 100. The vehicle 210 comprises a monitoring device 212 which is equipped to determine and/or monitor the actual and/or previous use of the pressure container system 100. The pressure container system 100 may, for example, as shown in FIG. 1, comprise at least one pressure sensor 114, which is, for example, set up to acquire sensor data in relation to the internal pressure in the pressure container 110 and/or in relation to the pressure in the line 112. The monitoring device 212 may be set up to determine the number of cycles of the pressure container 110 on the basis of the sensor data of the pressure sensor 114.

In particular, the monitoring device 212 may be set up to determine usage data 215 in relation to the actual use of the pressure container system 100 (for example, on the basis of the sensor data of one or more sensors 114 of the pressure container system 100). The usage data can indicate, for example,
the actual number of cycles of the pressure container 110;
the actual maximum pressure to which the pressure container 110 was exposed;
the actual minimum pressure to which the pressure container 110 was exposed;
the actual maximum temperature to which the pressure container 110 was exposed;
the actual minimum temperature to which the pressure container 110 was exposed; and/or
the previous service life of one or more components, in particular of the pressure container 110, of the pressure container system 100.

The usage data 215 in relation to the actual (cumulative) use of the pressure container system 100 may be stored in a memory unit 211 of the vehicle 200.

The monitoring device 212 may be set up to determine, on the basis of the usage data 215, whether the nominal use of the pressure container system 100 has been reached or exceeded. Furthermore, the monitoring device 212 may be set up to initiate one or more protective or safety measures if it is determined that the nominal use of the pressure container system 100 has been reached or exceeded. Exemplary measures are:
blocking the use and/or operation of the pressure container system 100; or
issuing a notice to a user of the pressure container system 100 (for example via a user interface 214 of the vehicle 210).

The pressure container system 100 can then be checked by a (certified) maintenance service and replaced if appropriate. Following the maintenance, the pressure container system 100 can then be unblocked.

The local monitoring of the use of a pressure container system 100 in a vehicle 210 carries the risk that the locally stored usage data 215 may be manipulated to avoid blocking the pressure container system 100. This can lead to an increased risk of the selection of the pressure container system 100 and the vehicle 210.

The vehicle 210 may have a communication unit 213 which is designed to establish a (possibly wireless) communication link 202 to a vehicle-external unit 201 (for example to a backend server or to an external database). The monitoring device 212 of the vehicle 210 may be set up to send data 204 in relation to the actual use of the pressure container system 100 via the communication link 202 to the external unit 201. If necessary, the usage data 215 can be sent to the external unit 201.

The external unit 201 may be set up to determine and store external usage data 215 in relation to the actual use of the pressure container system 100 on the basis of the provided data in relation to the actual use of the pressure container system 100. The external usage data 215 can correspond to the (local) usage data 205 stored in the memory unit 211 of the vehicle 100 (as long as no manipulation of the local usage data 205 has taken place).

The external unit 201 may be designed to protect the external usage data 215 from unauthorized access and/or manipulation. This can be achieved, for example, by using a blockchain-based database.

The monitoring device 212 of the vehicle 210 may be set up to compare the external usage data 205 with the local usage data 215 in the context of the monitoring of the pressure container system 100. In particular, it can be checked whether the external usage data 205 differ from the local usage data 215 or not. If a deviation of the external usage data 205 from the local usage data 215 is detected, a protection and/or safety measure may be initiated, in particular if the external usage data 205 indicate that the nominal use of the pressure container system 100 has been reached or exceeded.

Alternatively or in addition to the comparison of the local usage data 205 with the external usage data 215, the monitoring device 212 may be set up to check the plausibility of the local usage data 205, in particular on the basis of the sensor data of one or more vehicle sensors 216. Exemplary information items that can be used to check the plausibility of the local usage data 205 are:

The distance travelled by the vehicle 210, in particular the mileage of the odometer of the vehicle 210. The distance travelled can be compared, for example, with the number of cycles of the pressure container system 100 indicated by the local usage data 215. An insufficient number of cycles compared to the distance travelled may indicate a manipulation of the local usage data 215.

The time between two consecutive cycles of the pressure container 110, and/or the time interval between two refueling operations.

By taking into account additional information to check the plausibility of the local usage data 215, the reliability of the use of the pressure container system 100 can be further increased.

In other words, a control unit 212 is described which is designed to check whether a design parameter (i.e., a nominal use) of a relevant component 110, 112 of the pressure container system 100 has been exceeded or not. If an exceedance is detected, blocking and/or decommissioning of the system 100 can be initiated. The block can be maintained until the relevant component 110, 112 of the system 100 has been tested and replaced, if appropriate.

To ensure that the history of a component 110, 112 of the system 100 is not manipulated or that a block of the system 100 is not lifted without a service measure, a comparison is carried out with usage data 205 from a security-related database 201, for example from a blockchain-based database. In this way, it can be prevented that a blocked component 110, 112 of the pressure container system 100 is put back into operation by manipulation. Thus a database 201 (if appropriate, a blockchain-based database) can be used to monitor the refueling cycle counter for the pressure container 110 of a pressure container system 100.

In the context of the comparison the following may be carried out:
a comparison of the stored periods of use and the date of the system time of the vehicle 210;
a notification and counting of each cycle of the pressure container system 100 and a comparison of the counter states in the vehicle 210 or in the database 201;
a notification and, if appropriate, counting of exceedances of design-relevant physical state variables, such as temperature, pressure, density, mass flow and/or pressure gradient.

Possible measures in the event of a detected exceedance of one or more design values and/or in the event of a suspicion of manipulation are:
blocking the system 100;
issuing a notification to the owner and/or proprietor of the system 100;
locating the system 100;
issuing a message to a maintenance service for the maintenance of the system 100; or
issuing a notification to an official body and/or to the police.

Alternatively or in addition, the database 201 can be used to detect whether the recording of the relevant events by the system 100 has been manipulated. For example, an implausible use of the system 100, such as an unusually long time without a recorded refueling cycle, may possibly cause a notification and/or a check of the situation by comparing it with one or more other system usage data items.

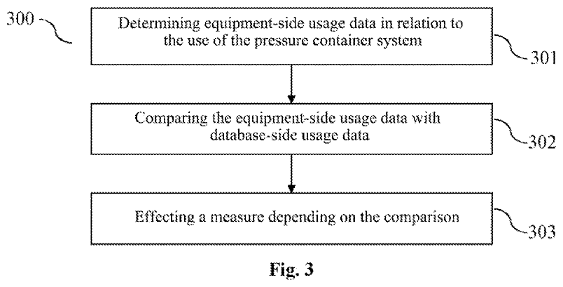

FIG. 3 shows a flow diagram of an exemplary (possibly computer-implemented) method 300 for monitoring the use of a pressure container system 100 of an equipment 210, in particular a motor vehicle.

The method 300 includes the determination 301 of equipment-side usage data 215 in relation to the previous use of the pressure container system 100. The equipment-side usage data 215 can be stored locally in a memory unit 211 of the equipment 210. The equipment-side usage data 215 can describe in a cumulative manner the previous use of the pressure container system 100 (since commissioning).

Furthermore, the method 300 includes the comparison of 302 of the equipment-side usage data 215 with equipment-external usage data 205 in relation to the previous use of the pressure container system 100. The equipment-external usage data 205 may be stored on an external unit 201 (in particular on a database) outside the equipment 210. The equipment-external usage data 205 can describe in a cumulative manner the previous use of the pressure container system 100 (since commissioning).

Normally, the equipment-side usage data 215 should indicate or have the same information with regard to the previous use of the pressure container system 100 as the equipment-external usage data 205. However, due to a manipulation of the equipment-side usage data 215, there may be a deviation between the equipment-side usage data 215 and the equipment-external usage data 205.

The method 300 also includes effecting 303 one or more measures in relation to the continued use of the pressure container system 100 depending on the comparison. The one or more measures can be effected in particular if the comparison results in a deviation between the equipment-side usage data 215 and the equipment-external usage data 205. As a measure, for example, the further use of the pressure container system 100 can then be blocked or prevented. This enables reliable monitoring of the use of the pressure container system 100.

The present disclosure is not limited to the exemplary embodiments indicated. In particular, it should be noted that the description and the figures are intended only to illustrate the principle of the proposed methods, devices and systems.

### REFERENCE CHARACTER LIST

100 pressure container arrangement
101 energy converter
102 refueling access
110 pressure container
111 end piece
112 line
114 pressure sensor
115 valve
200 system for monitoring a pressure container system
201 external unit (database)
202 communication connection
204 data relating to the use of the pressure container system
205 external usage data
210 motor vehicle
211 memory unit
212 monitoring device
213 communication unit
214 user interface
215 local usage data
216 vehicle sensor
300 method for monitoring a pressure container system
301-303 steps of the method

1-15. (canceled)

16. A device for monitoring the use of a pressure container system of an equipment, wherein the device is configured to:
determine equipment-side usage data in relation to previous use of the pressure container system;
compare the equipment-side usage data with equipment-external usage data in relation to the previous use of the pressure container system, wherein the equipment-side usage data and the equipment-external usage data indicate:
a maximum pressure, a minimum pressure and/or a maximum pressure gradient caused during the previous use of the pressure container system; and/or
a maximum and/or minimum temperature occurring during the previous use of the pressure container system; and
initiate one or more measures in relation to further use of the pressure container system depending on the comparison.

17. The device according to claim 16, wherein the device is configured to:
initiate the one or more measures in relation to the further use of the pressure container system if the comparison shows that the previous use of the pressure container system indicated by the equipment-side usage data deviates from the previous use of the pressure container system indicated by the equipment-external usage data.

18. The device according to claim 16, wherein the device is configured to:
determine on the basis of the comparison of the equipment-side usage data with the equipment-external usage data whether the equipment-side usage data have been changed and/or manipulated; and
initiate the one or more measures relating to the further use of the pressure container system if it is determined that the equipment-side usage data have been changed and/or manipulated.

19. The device according to claim 16, wherein the one or more measures in relation to the further use of the pressure container system include:
blocking and/or preventing the further use of the pressure container system;
issuing a notice to a maintenance service and/or to an official body and/or to a user of the equipment indicating that, prior to the further use of the pressure container system, a review of the previous use of the pressure container system and/or maintenance of the pressure container system is required; and/or
locating the pressure container system to allow a review of the previous use of the pressure container system and/or maintenance of the pressure container system.

20. The device according to claim 16, wherein the device is configured to:
determine on the basis of the equipment-side usage data and/or on the basis of the equipment-external usage data whether nominal use of the pressure container system has been reached or exceeded by the previous use of the pressure container system; and
initiate the one or more measures relating to the continued use of the pressure container system if it is determined that the previous use of the pressure container system has reached or exceeded the nominal use of the pressure container system.

21. The device according to claim 20, wherein the nominal use includes:
a nominal number of usage cycles of the pressure container system;
a nominal service life of the pressure container system;
a nominal pressure and/or a nominal pressure gradient during the use of the pressure container system; and/or
a nominal temperature during the use of the pressure container system.

22. The device according to claim 16, wherein the equipment-side usage data and/or the equipment-external usage data indicate:
a total number to date of cycles of use of the pressure container system; and/or
a previous service life of the pressure container system.

23. The device according to claim 16, wherein the device is configured to:
obtain the equipment-external usage data from an external unit arranged outside the equipment; and/or
store the data on an external unit arranged outside the equipment.

24. The device according to claim 16, wherein the equipment-external usage data are protected from manipulation and/or modification by one or more security methods.

25. The device according to claim 16, wherein the device is configured to:
obtain the equipment-side usage data from a memory unit of the equipment; and/or
store the data in a memory unit of the equipment.

26. The device according to claim 16, wherein the pressure container system is designed to be used during operation of the equipment, and
wherein the device is configured to:
determine operating data relating to the operation of the equipment; and
compare the equipment-side usage data and/or the equipment-external usage data with the operating data in order to check whether the equipment-side usage data and/or the equipment-external usage data have been manipulated and/or changed.

27. The device according to claim 26, wherein the operating data indicate:
an operating power of the equipment; or
an operating time of the equipment.

28. The device according to claim 16, wherein the device is configured to:
determine current data in relation to a current use of the pressure container system on the basis of sensor data from one or more sensors of the pressure container system; and
send the current data to an external unit outside the equipment to enable the external unit to update the equipment-external usage data; and/or
update the equipment-side usage data on the basis of the current data.

29. The device according to claim 16, wherein
the pressure container system comprises one or more pressure containers for storing a fuel, or
the equipment comprises an energy converter which is set up to generate electrical energy for the operation of the equipment from fuel from the pressure container system, and/or
the equipment is a motor vehicle.

30. A method for monitoring the use of a pressure container system of an equipment, the method comprising:
determining equipment-side usage data in relation to previous use of the pressure container system;
comparing the equipment-side usage data with equipment-external usage data in relation to the previous use of the pressure container system, wherein the equipment-side usage data and the equipment-external usage data indicate:
a maximum pressure, a minimum pressure and/or a maximum pressure gradient caused during the previous use of the pressure container system; and/or
a maximum and/or minimum temperature occurring during the previous use of the pressure container system; and
initiating one or more measures in relation to further use of the pressure container system depending on the comparison.

31. The method according to claim 30, wherein the one or more measures are initiated if the comparison shows that the previous use of the pressure container system indicated by the equipment-side usage data deviates from the previous use of the pressure container system indicated by the equipment-external usage data.

32. The method according to claim 30, further comprising:
determining, based on the comparison of the equipment-side usage data with the equipment-external usage data, whether the equipment-side usage data have been changed and/or manipulated; and
initiating the one or more measures relating to the further use of the pressure container system if it is determined that the equipment-side usage data have been changed and/or manipulated.

33. The method according to claim 30, wherein initiating the one or more measures in relation to the further use of the pressure container system comprises:
blocking and/or preventing the further use of the pressure container system;
issuing a notice to a maintenance service and/or to an official body and/or to a user of the equipment indicating that, prior to the further use of the pressure container system, a review of the previous use of the pressure container system and/or maintenance of the pressure container system is required; and/or
locating the pressure container system to allow a review of the previous use of the pressure container system and/or maintenance of the pressure container system.

34. The method according to claim 30, further comprising:
determining, based on the equipment-side usage data and/or on the equipment-external usage data, whether nominal use of the pressure container system has been reached or exceeded by the previous use of the pressure container system; and
initiating the one or more measures relating to the further use of the pressure container system if it is determined that the nominal use of the pressure container system has been reached or exceed by the previous use of the pressure container system.

35. The method according to claim 34, wherein the nominal use includes:
a nominal number of usage cycles of the pressure container system;
a nominal service life of the pressure container system;
a nominal pressure and/or a nominal pressure gradient during the use of the pressure container system; and/or
a nominal temperature during the use of the pressure container system.
